(19) United States
(12) Patent Application Publication
(10) Pub. No.: US 2006/0043127 A1
(43) Pub. Date: Mar. 2, 2006

(54) Tactile fluid dispensing system with reinforcing spine

(76) Inventor: Susan L. Butler, Wildwood, MO (US)

Correspondence Address: SUSAN L. BUTLER, 18760 WILD HORSE FARM CT., WILDWOOD, MO, 63038, US

(21) Appl. No.: 10/929,907

(22) Filed: Aug. 30, 2004

(51) Int. Cl. B65D 47/00; B67D 3/00

(52) U.S. Cl. 222/556

(57) ABSTRACT

A beverage dispensing system that combines basic utilitarian functionality with a bladder system and reinforcing spine providing tactile enjoyment, flexibility, and durability when in use. The bladder system is made of flexible, squeezable, decorative and durable material that is reinforced with either an internal or external spine. The device, which is intended to be used during such activities as athletics, holds and dispenses consumable liquids while providing the user with enjoyment through surface textures, a unique structure, and semi-rigid design qualities.

### CROSS REFERENCE TO RELATED APPLICATIONS

This is an original application.

### STATEMENT REGARDING FEDERALLY SPONSORED RESEARCH & DEVELOPMENT

This invention did not utilize any Government funds and was not made under any Government contract.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This invention relates to athletic, sporting, and general outside activity devices, and more particularly to flexible, squeezable blob-like liquid dispensing containers for consumable fluids that is reinforced and stabilized with a spine system.

Conventional liquid hydration containers, such as bottles, canteens, flasks, and thermoses, have been designed and used for the most part as utilitarian delivery systems for needed body re-hydration during exercise or other activities. Kibbe in U.S. Pat. No. 5,890,636 and DiTomasso, et al in U.S. Pat. No. 6,126,041 describe liquid dispensing systems to be attached to the person comprised of lightweight, squeezable, durable material but does not offer a reinforcing spine to provide stability and rigidity to the unit allowing the unit to maintain its shape, remain flexible and squeezable and improve fluid dispensing when held in the user's hand(s) and placed to the user's mouth. A Flask For Cyclists is described in U.S. Pat. No. 4,667,881 by Michelotti. In this art, improvements are made to the actual dispensing of the beverage and to the ergonomic grip but, again, no improvements were incorporated to retain squeezable characteristics while improving the tactile enjoyment, stability and rigidity of the device. U.S. Pat. No. 6,651,845 by Schroeder describes a beverage container system that focuses on the use of pre-filled disposable bags that are placed into a reusable outer support. A described tube would be used to puncture the pre-filled bag. This embodiment does not offer the user the flexibility to use the device without the continued and expensive purchase of pre-filled, disposable bags. Fishler in U.S. Pat. No. 6,641,094 describes a plush bottle holder that forms animal or creature shapes that are cumbersome for use during athletic activities. Further, numerous devices exist that address utilitarian needs such as hands free use, improved liquid dispensing, and improved fasteners to the human body and sporting equipment but, prior art does not address the combined flexibility, squeeze-ability, stability, durability and tactile desires and requirements of older children and adults in athletic activities.

Accordingly, a flexible, squeezable, fluid dispensing system that is stabilized with a spine structure is needed that overcomes shortfalls in prior art. Specifically, a flexible fluid dispensing device made of flexible, squeezable material and reinforced with a stabilizing system is needed to provide (1) fluid delivery, (2) flexibility, (3) stability (4) durability, and (5) user enjoyment when holding and using the system. It is desirable to provide a device that addresses these five critical objectives.

### BRIEF SUMMARY OF THE INVENTION

The invention in one exemplary embodiment is a slightly curved, blob-like device that is comprised of flexible, squeezable material with a supporting spine for reinforcement and stabilization as well as a cap assembly and fastener. The unit encompasses four main components. The first functional component, which I will call the IFIC (Internal Fluid and Ice Compartment), is intended to hold a variety of hot or cold beverages as well as ice, if desired, which is to be consumed by the user. The IFIC can be either a reusable or disposable unit. The second functional component, which I will refer to as the EB (External Bladder) is comprised of a squeezable, blob-like material intended to house, insulate, and protect the IFIC as well as provide the user with enjoyment due to its shape, feel, design, color and flexibility. The third functional component is the reinforcing Spine that can be external or internal to the unit. The Spine is made of a more rigid material and provides for stability when the unit is in use and adds decorative qualities when placed externally on the unit. The fourth component is the Cap Assembly. This assembly is a removable device used for filling the unit and dispensing the fluid to the user.

In another exemplary embodiment, the functions and construction of the IFIC (Internal Fluid and Ice Compartment) and the EB (External Bladder) can be combined into one component. The other components including the Reinforcing Spine and the Cap Assembly remain the same.

With either embodiment described, the entire unit can optionally be covered by an exterior jacket or sleeve for further customization by the user. The optional, removable sleeve is held in place by a functional ring housed within the Cap Assembly. This ring is referred to as a fabric locking ring.

### BRIEF DESCRIPTION OF THE SEVERAL VIEWS OF THE DRAWINGS

FIG. 1 is a perspective view of the Tactile Fluid Dispensing System With Reinforcing Spine shown with the optional, decorative sleeve and handgrip in place,

FIG. 2 is a perspective view of the system with the optional, decorative sleeve removed and the Reinforcing Spine placed on the exterior of the bladder. Also shown are optional bumps on the bladder system for added gripping power and further enhancement of tactile enjoyment,

FIG. 3 is a perspective view of the IFIC (Internal Fluid and Ice Compartment) when not functionally combined with the external bladder. Optionally, the IFIC functions could be incorporated into the external bladder,

FIG. 4 is a perspective side view of a Cap Assembly,

FIG. 5 is a perspective view of the fabric locking collar that attaches to the main cap assembly

FIG. 6 is a perspective top view of the Cap Assembly

### DETAILED DESCRIPTION OF THE INVENTION

In the specific embodiment illustrated, an elongated, slightly curved device is shown, however, the device can be manufactured in various shapes, sizes, colors, and materials. The unit encompasses four main components A) one component to house the consumable liquids and solids (such as ice), B) one component to protect and insulate the consumable liquid compartment as well as provide user enjoyment due to its soft, flexible, squeezable, and blob-like characteristics, C) one component which is the reinforcing spine of the unit that increases the stability and decorative qualities and D) a cap assembly allowing for both filling and dispensing activities. Optional features include, but are not limited to, an exterior jacket for additional decorative and tactile characteristics and a hook/fastener device for the user to attach to their body, clothing or other items such as a sports bag. All of the components illustrated can be made from a number of different fabrics and materials, including different colors, designs, writings and artwork not limited in any way to the specific embodiment depicted in the diagrams.

In another exemplary embodiment, the functions and construction of the IFIC (internal Fluid and Ice Compartment) and the EB (External Bladder) are combined into one component. The other components including the Reinforcing Spine, the Cap Assembly, and outer jacket/cover remain the same.

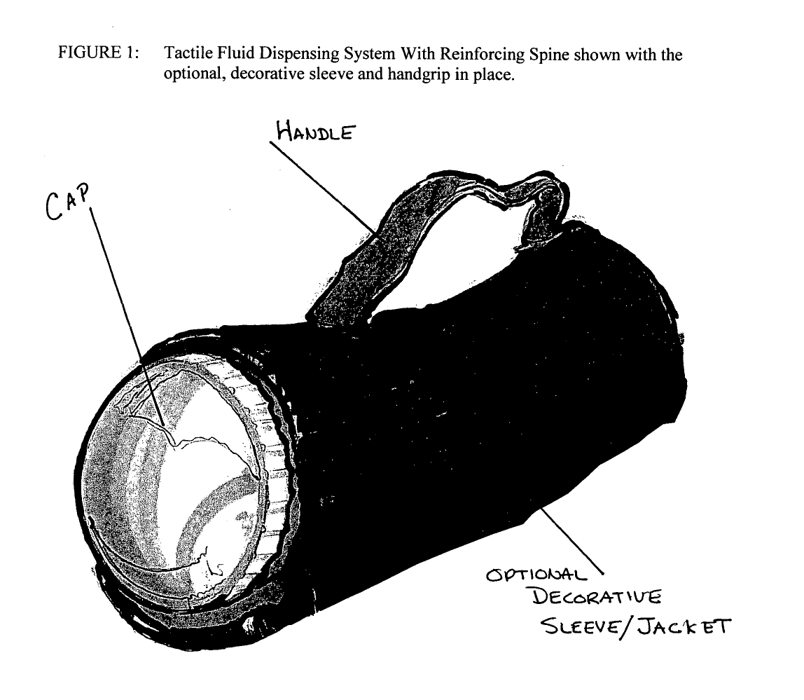

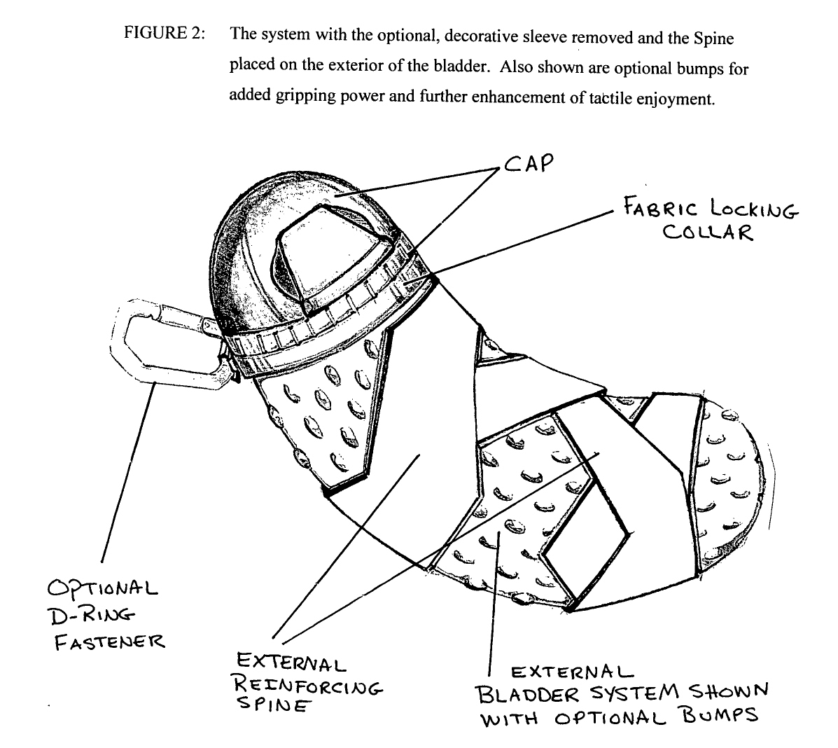

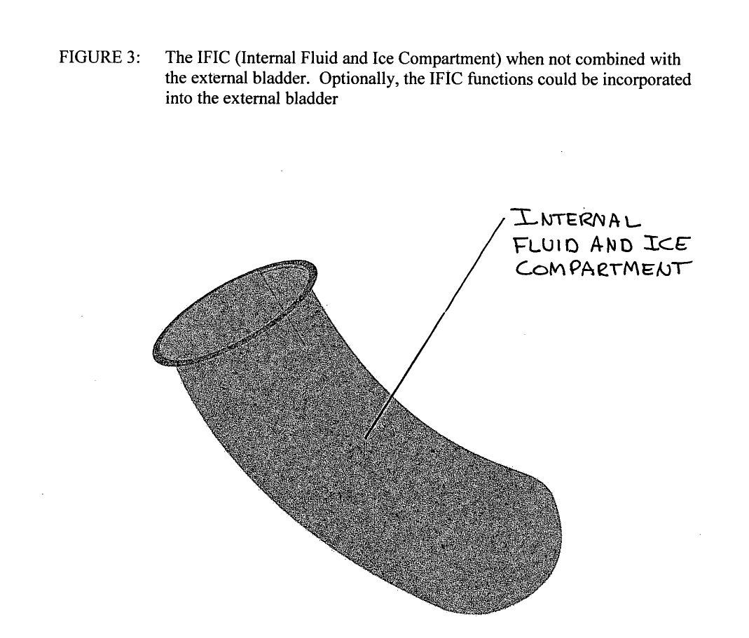

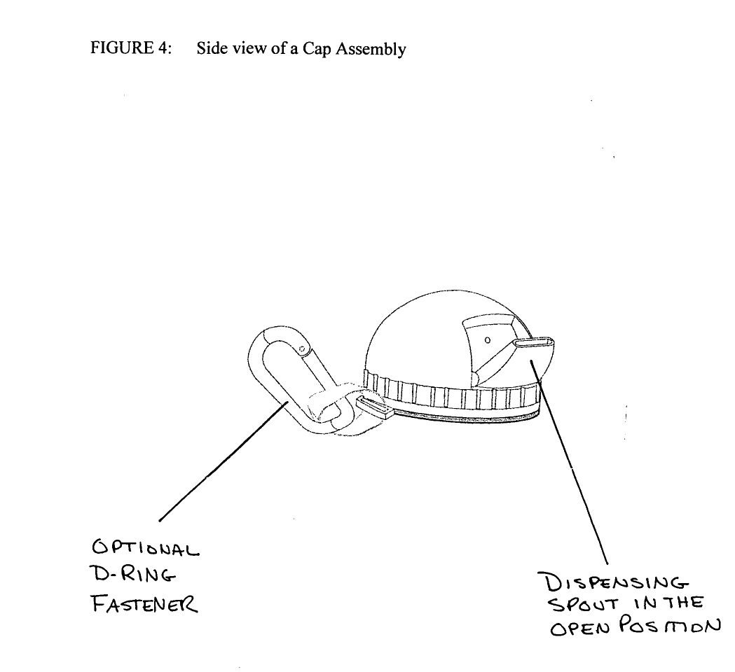

Referring to FIG. 1, the device is shown with an optional fabric sleeve (held in place by a locking fabric collar in the cap assembly) and a D-ring fastener to allow the user to attach the unit to an item such as a sports bag or article of clothing. Referring to FIG. 2, which illustrates the device without the optional outer jacket/cover. This embodiment illustrates the reinforcing spine placed on the outside of the unit to provide increased unit stability and decorative characteristics. (Optionally, the reinforcing spine can be placed internally within the unit for its reinforcement function only). The reinforcing spine is comprised of a somewhat rigid, flexible, squeezable material. The exterior bladder is shown in this illustration with optional bumps for increased gripping capability and further enhanced feel. The external bladder is comprised of a soft, flexible material to provide tactile enjoyment through it's texture and minimal structure characteristics. Referring to FIG. 3, the Internal Fluid and Ice Compartment is shown. This component can be permanently installed and reused or disposable liners in the same shape can be accommodated in conjunction with the cap assembly collar. Referring to FIG. 4, an example cap assembly is illustrated. The cap assembly can be removed to fill and empty the unit and the spout is used for dispensing fluids as desired by the user. In this example, the cap assembly also accommodates a fastener/hook to accommodate a user's need to attach the unit to another item, such as a sports bag.

In prior art, attempts were made to address the need for portable personal hydration devices that promoted basic features and functions but they did not address or improve the feel of unit or the enjoyment level when held by the user. Blob-like, squeezable, flexible tactile characteristics in conjunction with basic fluid dispensing abilities are desired by athletes of all ages. During exercise periods, athletes take pleasure in refreshing activities such as the consumption of fluids. The tactile fluid dispensing system with a reinforcing spine increases the hydration pleasure and enjoyment by providing a unique sensation to the user's hand(s).

The Tactile Fluid Dispensing System with Reinforcing Spine proposed is capable of addressing the need for a sporting hydration and the desire to have a soft, squeezable, flexible, durable, decorative unit that provides a certain level of rigidity when in use.

While there have been described above the principles of this invention in connection with specific apparati, it should be clearly understood that this description is made only by way of example, and not as a limitation to the scope and specific embodiment of the invention. The invention is forward looking in encompassing future materials that may be introduced into the market that would improve functionality, durability, comfort and/or appearance.

### DETAILED DESCRIPTION OF THE PREFERRED EMBODIMENT—DRAWINGS

The present invention provides a personal hydration unit that can be used for the storage and delivery of hot or cold liquids in various weather conditions while providing a pleasurable sensation when holding and using the unit.

FIG. 1 is a perspective view of the Tactile Fluid Dispensing System With Reinforcing Spine with the optional, decorative sleeve/jacket and handgrip in place. The optional sleeve, attached by a fabric locking ring, allows users to further customize their hydration device to better suit their needs and preferences.

FIG. 2 is a perspective view of the system with the optional, decorative sleeve removed and the Reinforcing Spine placed on the exterior of the bladder. Also shown are optional bumps for added gripping power and further enhancement of tactile enjoyment. The unit is shown with an optional D-Ring Fastener for easy attachment to items of clothing or other equipment such as a sports bag or bicycle. A fabric locking collar is illustrated as an option for the user to attach an exterior, decorative sleeve/jacket.

FIG. 3 is a perspective view of the IFIC (Internal Fluid and Ice Compartment) when it's functions are not combined with the external bladder. Optionally, the IFIC functions could be incorporated into the external bladder,

FIG. 4 is a perspective side view of a Cap Assembly with a fabric locking collar or ring. The dispensing spout is shown in the open position. An optional D-ring fastener is also illustrated,

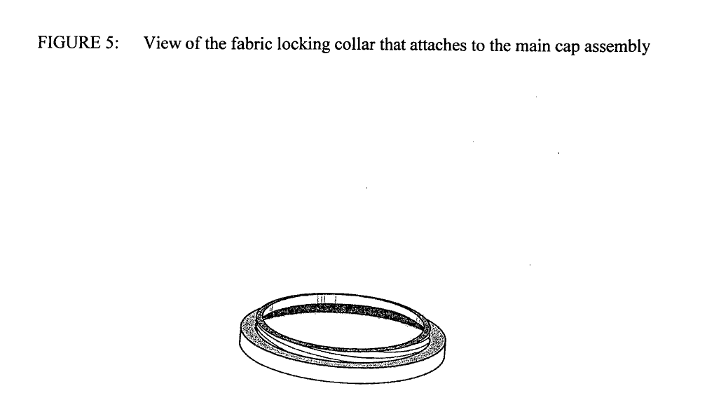

FIG. 5 is a perspective view of the fabric locking collar that attaches to the main cap assembly and allows users to add decorative sleeves/jackets as desired,

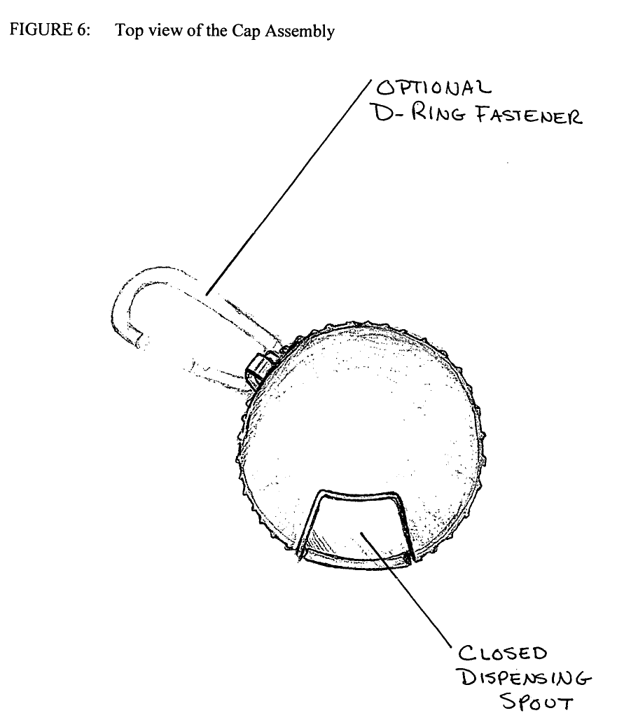

FIG. 6 is a perspective top view of the Cap Assembly shown with an optional D-Ring Fastener for easy attachment to items of clothing or other equipment such as a sports bag or bicycle. The dispensing spout in this illustration is in the closed position.

While a preferred embodiment of the present invention has been described, it should be understood that various changes, adaptations and modifications might be made therein without departing from the spirit of the invention and the scope of the claims.

1. A Tactile Fluid Dispensing System With Reinforcing Spine comprising: (1) an IFIC (Internal Fluid and Ice Compartment) (2) an EB (External Bladder with durable, squeezable characteristics), (3) a reinforcing spine for added unit stability and its decorative quality, (4) a cap assembly, and (5) optional, removable, decorative jacket and (6) optional fastener.

2. A Tactile Fluid Dispensing System With Reinforcing Spine comprising: (1) an EB (External Bladder with durable, squeezable characteristics) with combined functionality to serve as the external bladder and the IFIC (Internal Fluid and Ice Compartment), (2) a reinforcing spine for added unit stability and its decorative quality, (3) a cap assembly, and (4) optional, removable, decorative jacket and (5) optional fastener.

3. A Tactile Fluid Dispensing System With Reinforcing Spine in accordance with claim 1 and claim 2 whereas the separate IFIC (Internal Fluid and Ice Compartment) can be a reusable or support the use of a disposable bladder liner.

4. A Tactile Fluid Dispensing System With Reinforcing Spine in accordance with claim 1 and claim 2 wherein an accessible compartment (IFIC—Internal Fluid and Ice Compartment or a combined IFIC and EB—External Bladder combination) is available for storing liquids and solids (such as water and ice) for the user's consumption.

5. A Tactile Fluid Dispensing System With Reinforcing Spine in accordance with claim 1 and claim 2 wherein an External Bladder protects and insulates the IFIC (Internal Fluid and Ice Compartment).

6. A Tactile Fluid Dispensing System With Reinforcing Spine in accordance with claim 1 and claim 2 wherein an External Bladder is comprised of a flexible, squeezable material for the user's enjoyment.

7. A Tactile Fluid Dispensing System With Reinforcing Spine in accordance with claim 1 and claim 2 wherein an External Bladder can support both smooth and bumpy surfaces to improve the user's grip.

8. A Tactile Fluid Dispensing System With Reinforcing Spine in accordance with claim 1 and claim 2 wherein a reinforcing Spine (placed internally or externally) provides increased stability and rigidity to the unit when in use.

9. A Tactile Fluid Dispensing System With Reinforcing Spine in accordance with claim 1 and claim 2 wherein a Cap Assembly provides for filling and dispensing activities.

10. A Tactile Fluid Dispensing System With Reinforcing Spine in accordance with claim 1 and claim 2 wherein a Cap Assembly provides a locking mechanism to hold an optional, exterior decorative sleeve.

11. A Tactile Fluid Dispensing System With Reinforcing Spine in accordance with claim 1 and claim 2 wherein a Cap Assembly provides a integrated connection point for optional fasteners or belts to be attached.
